(19) United States
(12) Patent Application Publication
(10) Pub. No.: US 2022/0170670 A1
(43) Pub. Date: Jun. 2, 2022

(54) AN IMPROVED SYSTEM FOR CONCENTRATING, COLLECTING, AND TRANSMITTING SUNLIGHT

(71) Applicant: NIKHIL GAIKWAD, NAVI MUMBAI (IN)

(72) Inventor: NIKHIL GAIKWAD, NAVI MUMBAI (IN)

(21) Appl. No.: 17/286,811

(22) PCT Filed: Sep. 1, 2020
(86) PCT No.: PCT/IN2020/050760

§ 371 Date: Apr. 19, 2021

(30) Foreign Application Priority Data
Feb. 20, 2020 (IN) 202023007333

(51) Int. Cl. F24S 23/30; F24S 23/77; B64G 1/68

(52) U.S. Cl. CPC F24S 23/30; B64G 1/68; F24S 23/77

(57) ABSTRACT

An improved system for concentrating, collecting, and transmitting sunlight, comprises: a first plurality of lens panels that is disposed in at least one location in an origin for collecting sunlight; a central collection point that receives the collected sunlight, said collected sunlight being transmitted from the collection point to at least one concentrating lens, said at least one concentrating lens generating a sharp and strong beam, which is transmitted to a first satellite; a first reflecting portion that reflects the concentrated beam to a second satellite; and a second reflecting portion that reflects the concentrated beam through a second pre-defined distance to an at least one receiver unit, said at least one receiver unit transmitting the sunlight to a receiving point that is disposed in at least one location in the destination for collecting sunlight. The sunlight collected in the destination can be used for various purposes.

### CROSS REFERENCE TO EARLIER APPLICATIONS

The present disclosure is an improvement in or modification of the disclosure in my earlier patent application bearing number 1621/MUM/2015 dated Apr. 21, 2015.

### FIELD OF THE INVENTION

The present disclosure is generally related to a system for concentrating, collecting, and transmitting sunlight. Particularly, the present disclosure is related to a system for concentrating, collecting, and transmitting sunlight over long distances.

### BACKGROUND OF THE INVENTION

Systems for concentrating, collecting, and transmitting sunlight are known in the art. Such systems typically concentrate, collect, and transmit sunlight over a short distance from an origin to a destination. Such systems are disclosed in Indian Patent Application 6803/DELNP/2011, 581/KOLNP/2014, 529/DELNP/2011, and IN/PCT/2001/00804/MUM.

There are various other prior arts that are related to concentration, collection, and transmission of solar energy over short distances; which disclose a parabolic reflector. The use of a parabolic reflector is associated with high energy losses, thereby decreasing the efficiency of the system.

However, oftentimes, concentrating, collecting, and transmitting sunlight over short distances alone is not sufficient, and there exists a requirement for concentrating, collecting, and transmitting sunlight over long distances, such as across mountains, rivers, sea, or oceans.

There is, therefore, a need in the art for a system for concentrating, collecting, and transmitting sunlight, which overcomes the aforementioned drawbacks and shortcomings.

### SUMMARY OF THE INVENTION

An improved system for concentrating, collecting, and transmitting sunlight is disclosed. The system comprises: a first plurality of lens panels; a central collection point; at least one concentrating lens; a first satellite; a first reflecting portion; a second satellite; a second reflecting portion; and at least one receiver unit.

The first plurality of lens panels is disposed in at least one location in an origin for collecting sunlight, with each lens panel in the first plurality of lens panels being associated with each other to create a network, and to pass on the collected light sequentially.

The central collection point receives the collected sunlight that is transmitted from each lens panel in the first plurality of lenses, said collected sunlight being transmitted from the collection point to at least one concentrating lens.

The at least one concentrating lens concentrates the collected sunlight to generate a sharp and strong beam, which is subsequently transmitted to the first satellite.

The first reflecting portion reflects the concentrated beam from the first satellite to the second satellite, while the second reflecting portion reflects the concentrated beam from the second satellite to the at least one receiver unit.

### BRIEF DESCRIPTION OF THE DRAWINGS

FIG. 1 illustrates an embodiment of an improved system for collecting, concentrating, and transmitting sunlight, in accordance with the present disclosure

### DESCRIPTION OF THE INVENTION

Throughout this specification, the use of the word “comprise” and “include”, and variations such as “comprises”, “comprising”, “includes”, and “including” may imply the inclusion of an element or elements not specifically recited.

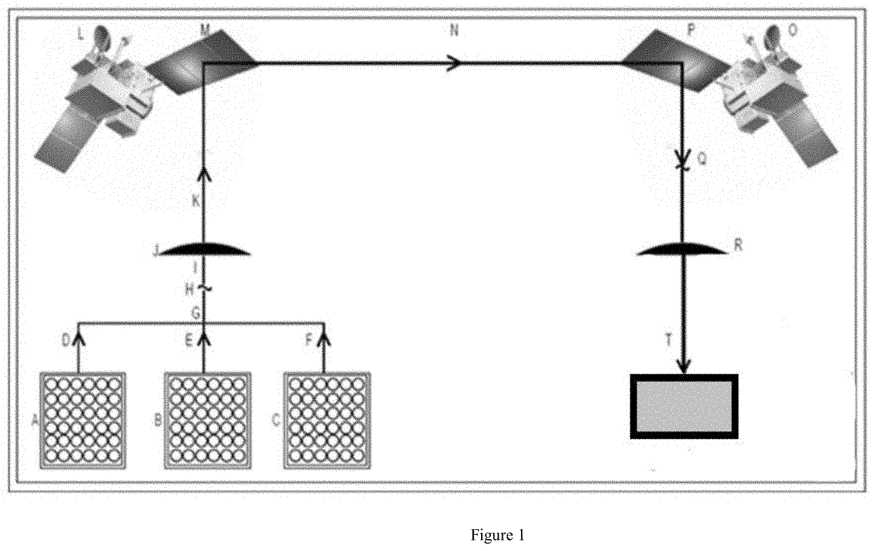

An improved system for concentrating, collecting, and transmitting sunlight is disclosed. As illustrated in FIG. 1, an embodiment of the system comprises a first plurality of lens panels (A, B, and C) that is disposed in at least one location in an origin for collecting sunlight.

Each lens panel in the first plurality of lens panels (A, B, and C) comprises a plurality of lenses that is disposed across a plurality of layers, with: the lenses in the top layer being bigger in size and concentrating incident sunlight; the lenses in the subsequent layer gathering the collected sunlight and focusing the collected sunlight to an even smaller area, and so on, till the lenses in the bottom layer, which bring the entire incident sunlight to a tiny point.

Once the incident sunlight is brought to a tiny point, it is collected and transmitted to a desired destination via transmission channels having internal reflection. The transmission channels are pipes of any suitable material (plastic, metal, rubber, etc.), either hollow or filled with material that facilitates light transmission, such as glass, optical fiber, gas, space etc.

The channels comprise reflective coating or reflective material on their inner walls, so that they reflect light and light travels forward with minimum losses.

The lens panels in the first plurality of lens panels (A, B, and C) are associated with each other to create a network or mesh, and to pass on the collected light sequentially. This creates a large amount of collected sunlight, thereby increasing the intensity of the output.

The lens panels may be set up sequentially in row, or besides each other on plane ground, farms, or even on the walls of any building.

The sunlight collected by each lens panel (D, E, and F) is transmitted to a central collection point (G). Thus, the central collection point (G) receives the collected sunlight (D, E, and F) that is transmitted from each lens panel. From the collecting point (G), the collected sunlight (D, E, and F) is transmitted through a first pre-defined distance (H) to at least one concentrating lens (J). The first pre-defined distance (H) may vary depending on the requirement.

The collected sunlight before it is concentrated to a beam (I) is transmitted to the at least one concentrating lens (J) that concentrates the collected sunlight to generate a sharp and strong beam (K), which is subsequently transmitted to a first satellite (L). The at least one concentrating lens (J) is disposed at a pre-defined height.

The first satellite (L) comprises a first reflecting portion (M) that reflects the concentrated beam (N) to a second satellite (O). The second satellite (O) comprises a second reflecting portion (P) that reflects the concentrated beam through a second pre-defined distance (Q) to an at least one receiver unit (R). The first satellite (L) and the second satellite (O) form an angle, whereby the sharp and strong beam of light (K) incident at the first reflecting portion (M) is reflected to the second reflecting portion (P), and then again reflected to the at least one receiver unit (R).

The second pre-defined distance (Q) may vary depending on the requirement.

The at least one receiver unit (R) comprises a plurality of convex lenses, from where the sunlight is transmitted to a receiving point (T) that is disposed in at least one location in the destination for collecting sunlight

The sunlight collected in the destination can be used for various purposes, including, but not limited to: source of light for illumination in houses, offices, roads, open areas, stadiums, or as source for energy for heating, boiling, melting etc.

The disclosed system collects, concentrates, and transmits solar energy over long distances without any conversion, reducing conversion losses. Further, the disclosed system is durable.

In an embodiment of the present disclosure, each lens panel in the first plurality of lenses and/or the second plurality of lenses is of size 1 foot by 1 foot.

In another embodiment of the present disclosure, each lens panel in the first plurality of lenses and/or the second plurality of lenses is of size 10 feet by 10 feet.

In yet another embodiment of the present disclosure, the at least one receiver unit (R) is of any kind; it may or may not comprise lenses.

It will be apparent to a person skilled in the art that the above description is for illustrative purposes only and should not be considered as limiting. Various modifications, additions, alterations and improvements without deviating from the spirit and the scope of the disclosure may be made by a person skilled in the art. Such modifications, additions, alterations and improvements should be construed as being within the scope of this disclosure.

### LIST OF REFERENCE NUMERALS

A, B, and C—First Plurality of Lens Panels
D, E, and F—Sunlight Collected by Each Lens Panel in the First Plurality of Lens Panels
G—Central Collection Point
H—First Pre-Defined Distance
I—Collected Sunlight Before it is Concentrated to a Beam
J—At Least One Concentrating Lens
K—Strong and Sharp Beam
L—First Satellite
M—First Reflecting Portion
N—Concentrated Beam
O—Second Satellite
P—Second Reflecting Portion
Q—Second Pre-Defined Distance
R—At Least One Receiver Unit
T—Receiving Point

I claim:

1. An improved system for concentrating, collecting, and transmitting sunlight, comprising:
a first plurality of lens panels that is disposed in at least one location in an origin for collecting sunlight, with each lens panel in the first plurality of lens panels being associated with each other to create a network, and to pass on the collected light sequentially;
a central collection point that receives the collected sunlight that is transmitted from each lens panel in the first plurality of lenses, said collected sunlight being transmitted from the collection point to at least one concentrating lens;
the at least one concentrating lens that concentrates the collected sunlight to generate a sharp and strong beam, which is subsequently transmitted to a first satellite;
a first reflecting portion that reflects the concentrated beam from the first satellite to a second satellite, said first satellite and said second satellite forming an angle;
a second reflecting portion that reflects the concentrated beam from the second satellite to an at least one receiver unit; and
the at least one receiver unit that comprises a plurality of convex lenses, from where the sunlight is transmitted to a receiving point that is disposed in at least one location in the destination for collecting sunlight.
